(19) United States
(12) Patent Application Publication
(10) Pub. No.: US 2022/0090715 A1
(43) Pub. Date: Mar. 24, 2022

(54) REMANUFACTURED HYDRAULIC CYLINDER AND CYLINDER COUPLER THEREFOR

(71) Applicant: Cabriolet Hydraulics, LLC, Sarasota, FL (US)

(72) Inventor: Zbigniew Robert Paul, University Park, FL (US)

(21) Appl. No.: 17/479,755

(22) Filed: Sep. 20, 2021

Related U.S. Application Data
(60) Provisional application No. 63/080,520, filed on Sep. 18, 2020.

(51) Int. Cl. F16L 33/207

(52) U.S. Cl. CPC F16L 33/2076

(57) ABSTRACT

A convertible hose connector assembly includes a clamping nut, a crimp sleeve, a hose insert, and a replacement pipe. The crimp sleeve is coupled to the hose insert and the hose insert is coupled to the replacement pipe. The replacement pipe replaces a coupler coupled to a convertible top hydraulic cylinder prior to being remanufactured to produce a remanufactured convertible top hydraulic cylinder. The remanufactured convertible top hydraulic cylinder including at least one of the hose connector assembly.

### CROSS-REFERENCE TO RELATED APPLICATION

This application claims priority from U.S. Patent Application Ser. No. 63/080,520 filed Sep. 18, 2020, entitled Remanufactured Hydraulic Cylinder and Elbow Coupler Therefor, the entire specification of which is hereby incorporated by reference in its entirety.

### BACKGROUND OF THE DISCLOSURE

### 1. Field of the Disclosure

The disclosure relates in general to a hydraulic cylinder and coupler thereof, and more particularly, to a remanufactured hydraulic cylinder and cylinder coupler thereof which are particularly well suited for repairing flexible hoses, such as hydraulic hoses or tubing. While not particularly limited thereto, the remanufactured hydraulic cylinder and cylinder coupler thereof are particularly well suited to the repair of flexible hoses of the type used with hydraulic cylinders, and more particularly, hydraulic cylinders typically utilized in association with convertible tops in automobiles. The disclosure is not limited to solely such a use.

### 2. Background Art

Hydraulic hoses are the means by which to convey hydraulic fluid in systems where a pump delivers pressurized fluid through a hose to a hydraulic actuator or cylinder. Such hydraulic actuators or cylinders are known in the art as a means for delivering linear or angular force to an object. The uses of such hydraulic actuators or cylinders is well known in the art of industrial robotics, construction equipment and automobiles.

For example, in the automotive arena, hydraulic systems are utilized to open and close convertible tops, trunks, hatches, hoods and doors, as well as with self-leveling suspension. Focusing on the automotive application for purposes of example solely, and not for purposes of limitation, hydraulic hoses in automotive applications are generally permanently attached to actuators. As such, the hoses are not readily removable and reattachable to the respective actuators or cylinders. In fact, the hoses and the actuator are coupled to the pump only and removable as a unit, typically. While the actuator may be located in any location within the vehicle, the hydraulic pump (with fluid reservoir) is generally located in the trunk. Among other examples of such configurations, the following vehicles utilize such a configuration: 2004 Mercedes-Benz model SL500, 1999 Mercedes-Benz model SLK 230, 2001 BMW model 325i and 2002 Ferrari model 360 Spyder. There are certainly others that are known to those of skill in the art.

In each of the foregoing, the cylinder/actuator with the permanently attached hoses can be very difficult to replace. For example, the actuator that is found at the front of a convertible top above the frame of a windshield includes hydraulic hoses that extend back into the trunk following a generally extremely convoluted path. The removal of the hoses may require the disassembly of interior panels and cutting away dozens of plastic straps from their hose attachment points. Such a removal and replacement may take on the order of ten or more man-hours.

In other instances, the original actuator itself may be fully operational, but a fitting or a joint may develop a leak at the actuator. Again, as the actuator is offered as a single unit, a full replacement is required.

These and other objects of the present disclosure will be set forth in the specification hereinbelow.

### SUMMARY OF THE DISCLOSURE

The disclosure is directed, in one aspect to a hose connector assembly comprising an attachment assembly, a crimping sleeve and a clamping nut. The attachment assembly includes a pipe, a hose insert and a hose insertion member. The pipe has a first end and a second end. The replacement pipe has an internal bore extending therethrough and a retention collar spaced apart from the second end. The hose insert is positioned at the first end of the pipe. The hose insert has a proximal end and a distal end, and a central bore that corresponds to the internal bore of the pipe, with an outer surface having a pattern disposed thereon. The hose insertion member is positioned between the pipe and the hose insert having an outer surface, and a second central bore that corresponds to the central bore of the hose insert, the hose insertion member defining a flange at the proximal end of the hose insert. The crimping sleeve is attachable to the hose insertion member. The crimping sleeve has an end body and a crimp sleeve. The crimp sleeve has an internal bore and an outer surface. The outer surface has a threaded portion and at least one relief slot extends through the crimp sleeve. The clamping nut has a bore with a threaded portion interfaceable with the threaded portion of the crimp sleeve. Tightening of the clamping nut directs the inner bore proximate the at least one relief slot toward the outer surface of the hose insert, whereupon a hose portion positioned therebetween can be clamped between the outer surface of the hose insert and the inner bore in sealed engagement.

In some configurations, the pipe further includes an elbow portion between the first end and the second end thereof.

In some configurations, the elbow portion comprises an angle of between 60° and 180°.

In some configurations, the crimping sleeve is attached to the hose insertion member through an interference fit a threaded engagement and a brazed connection.

In some configurations, the attachment assembly comprises a single monolithic member.

In some configurations, the hose insertion member further includes a stop collar positioned at a second side thereof, wherein the stop collar interfaces with the end body of the crimping sleeve.

In some configurations, the crimping sleeve further includes an outer surface configured for engagement by a wrench.

In some configurations, the crimping sleeve further includes an outer surface configured for engagement by a wrench.

In another aspect of the disclosure, the disclosure is directed to a hydraulic cylinder that includes a body and a hose connector assembly. The body has at least one port in communication with a cylinder having a rod slidably movable within the cylinder. The hose connector assembly includes an attachment assembly, a crimping sleeve and a clamping nut. The attachment assembly includes a pipe, a hose insert and a hose insertion member. The pipe has a first end and a second end. The replacement pipe has an internal bore extending therethrough and a retention collar spaced apart from the second end. The hose insert is positioned at the first end of the pipe. The hose insert has a proximal end and a distal end, and a central bore that corresponds to the internal bore of the pipe, with an outer surface having a pattern disposed thereon. The hose insertion member is positioned between the pipe and the hose insert having an outer surface, and a second central bore that corresponds to the central bore of the hose insert, the hose insertion member defining a flange at the proximal end of the hose insert. The crimping sleeve is attachable to the hose insertion member. The crimping sleeve has an end body and a crimp sleeve. The crimp sleeve has an internal bore and an outer surface. The outer surface has a threaded portion and at least one relief slot extends through the crimp sleeve. The clamping nut has a bore with a threaded portion interfaceable with the threaded portion of the crimp sleeve. Tightening of the clamping nut directs the inner bore proximate the at least one relief slot toward the outer surface of the hose insert, whereupon a hose portion positioned therebetween can be clamped between the outer surface of the hose insert and the inner bore in sealed engagement.

In some configurations, the pipe further includes an elbow portion between the first end and the second end thereof.

In some configurations, the elbow portion comprises an angle of between 60° and 180°.

In some configurations, the crimping sleeve is attached to the hose insertion member through an interference fit a threaded engagement and a brazed connection.

In some configurations, the attachment assembly comprises a single monolithic member.

In some configurations, the hose insertion member further includes a stop collar positioned at a second side thereof, wherein the stop collar interfaces with the end body of the crimping sleeve.

In some configurations, the crimping sleeve further includes an outer surface configured for engagement by a wrench.

In some configurations, the crimping sleeve further includes an outer surface configured for engagement by a wrench.

In some configurations, the hydraulic cylinder further includes a clip engageable with the retention collar of the pipe that is positioned within the port thereof, to preclude removal of the pipe from within the port.

In some configurations, the clip includes a fork portion with the pipe extending through the fork portion, and further comprising a fastener attaching the clip to the body.

In some configurations, the at least one port comprises a pair of ports, each having a hose connector assembly interfaced therewith.

In another aspect of the disclosure, the disclosure is directed to a method of rebuilding a cylinder comprising the steps of: removing at least one pipe from a port of a body of a cylinder; providing a hose connector assembly; inserting the pipe of the hose connector assembly into the port of a body of a cylinder; coupling the pipe so as to preclude removal from within the port; inserting a hose over the hose insert thereof; and fastening the clamping nut to the clamping sleeve so as to sealingly clamp the hose to the hose insert.

### BRIEF DESCRIPTION OF THE DRAWINGS

The disclosure will now be described with reference to the drawings wherein:

FIG. 1 illustrates an exploded view of a first configuration of an example hose connector assembly, in accordance with at least one configuration disclosed herein;

FIG. 2 illustrates an assembled view of the hose connector assembly shown in FIG. 1, in accordance with at least one configuration disclosed herein;

FIG. 3 illustrates a cut view of the hose connector assembly shown in FIG. 1, in accordance with at least one configuration disclosed herein;

FIG. 4 illustrates an exploded view of another example hose connector assembly, in accordance with at least one configuration disclosed herein;

FIG. 5 illustrates an assembled view of the hose connector assembly shown in FIG. 4, in accordance with at least one configuration disclosed herein;

FIG. 6 illustrates a cut view of the hose connector assembly shown in FIG. 4, in accordance with at least one configuration disclosed herein;

FIG. 6a illustrates a cross-sectional configuration of the hose connector assembly showing an elbow of 180°;

FIG. 6b illustrates a cross-sectional configuration of another configuration of the hose connector assembly, showing, in particular, a threaded engagement between the hose insertion member and the crimping sleeve;

FIG. 7 illustrates a side elevational view of the hose connector assembly shown in FIG. 1 prior to the coupling of a hose to the hose insert, in accordance with at least one configuration disclosed herein;

FIG. 8 illustrates a side elevational view of the hose connector assembly shown in FIG. 7, with an end of the hose being inserted over the hose insert, in accordance with at least one configuration disclosed herein;

FIG. 9 illustrates a side elevational view of the hose connector assembly shown in FIG. 7 with the clamping nut being directed into contact with the crimp sleeve, in accordance with at least one configuration disclosed herein;

FIG. 10 illustrates a side elevational view of the hose connector assembly shown in FIG. 7 with the hose connector assembly fully clamping the hose, to effectuate a repair, in accordance with at least one configuration disclosed herein;

FIG. 11 illustrates a cross-sectional view of the hose connector assembly shown in FIG. 7 with the clamping nut being directed into contact with the crimp sleeve, taken generally about lines 11-11 of FIG. 9, in accordance with at least one configuration disclosed herein;

FIG. 12 illustrates a cross-sectional view of the hose connector assembly shown in FIG. 7 with the assembly fully clamping the hose, to effectuate a repair, taken generally about lines 12-12 of FIG. 10, in accordance with at least one configuration disclosed herein;

FIG. 13 illustrates a schematic representation of an example typical hydraulic cylinder and pump assembly, showing, in particular, the cut locations wherein the splice repair can be undertaken to replace a faulty hydraulic cylinder with a remanufactured hydraulic cylinder, for example, or to repair a broken hydraulic cylinder, in accordance with at least one configuration disclosed herein;

FIG. 14 illustrates a schematic representation of the hydraulic cylinder and pump assembly configuration of FIG. 13, showing, in particular, the repaired configuration with a remanufactured hydraulic cylinder including a pair of hose connector assemblies, in accordance with at least one configuration disclosed herein; and

FIG. 15 illustrates an example remanufactured hydraulic cylinder including a pair of the hose connector assembly shown in FIG. 1, in accordance with at least one configuration disclosed herein.

### DETAILED DESCRIPTION OF THE DISCLOSURE

While this disclosure is susceptible of configuration in many different forms, there is shown in the drawings and described herein in detail a specific configuration(s) with the understanding that the present disclosure is to be considered as an exemplification and is not intended to be limited to the configuration(s) illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

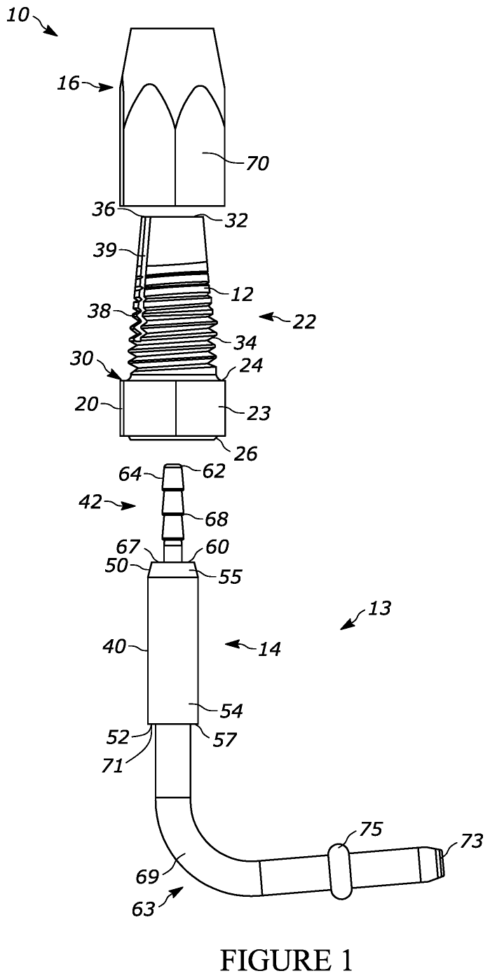

Referring now to the drawings and in particular to FIG. 1, a convertible hose connector assembly is shown generally at 10. The convertible hose connector assembly 10, as will be described below, and which is shown in the drawings, is configured for use in association with hydraulic lines of the type that are utilized with automotive hydraulic cylinders that control and actuate the movement of a convertible top, for example. Typically, the convertible hose connector assembly 10 is utilized to join to a hose end in sealed fluid communication. Typically, such hose is relatively high pressure and are generally quite stiff. Typically, although not required, the hoses are made of single or multiple annular layers of rubber, woven fabric, thermoplastic or other polymers. Generally, the hose has an inner bore diameter of approximately 1.5 to 2.5 mm (and most often a bore of 1.8 mm or 2.0 mm) with an outer diameter of approximately 3.5 to 5 mm. These are merely exemplary, and the disclosure is not limited to hoses of such dimensions.

The convertible hose connector assembly 10 is shown in the FIGS. 1-3 as comprising a crimping sleeve 12, an attachment assembly 13, and a clamping nut 16. The attachment assembly 13 includes a hose insert member 14, and a replacement pipe 63 (also referred to herein as pipe, with the understanding that a replacement pipe includes a new pipe or the same pipe previously used with the cylinder which can be reutilized with the crimping sleeve and clamping nut), which can be a single monolithic member, although alternatively can be distinct members that are fixed together. As will be explained, the hose insertion member 14 is inserted into the crimping sleeve 12, with the clamping nut 16 extending over a thread region 38 of the crimping sleeve 12. While the disclosure is not limited to the use of any particular materials, the components of the hose connector assembly may comprise metal materials, such as aluminum, brass, steel or stainless steel, or alloys thereof. The disclosure is not limited to the use of any particular materials.

The crimping sleeve 12 includes an end body 20 and a crimp sleeve 22. The end body 20 includes an outer surface 23, a first side 24, a second side 26 opposite the first side 24 and an internal bore portion 28. In at least one configuration, the outer surface 23 of the end body 20 is hexagonal in shape such that a wrench (e.g., open end wrench) can be used to prevent the crimp sleeve 22 from rotating while the clamping nut 16 is secured thereto. The crimp sleeve 22 extends from the first side 24 of the end body 20, and includes a proximal end 30, a distal end 32, an outer surface 34 and an internal bore 36. The proximal end 30 is at the first side of the end body 20. The outer surface 24 comprises a generally cylindrical portion that includes the threaded region 38 near the proximal end 30. The outer surface 23 tapers inwardly to a conical configuration toward the distal end 32 thereof. The threaded region 38 extends onto the conical portion. The conical portion further includes at least one relief slot 39 extending therethrough. In the configuration shown, two relief slots that are evenly spaced apart axially are shown. In other configurations, more or less relief slots can be utilized on opposing sides of each other.

The internal bore 36 comprises a generally uniform diameter opening of substantially uniform cross-sectional diameter. A plurality of surface patterns 37 are disposed along the internal bore 36, and especially along the portion which includes the at least one relief slot 39. In the configuration shown, the surface patterns 37 comprise a plurality of spaced apart teeth that extend in a direction that is perpendicular to the internal bore 36.

It will be understood that the internal bore portion 28 of the end body 20 and the internal bore 36 are collinear and generally, together, define the internal bore of the crimping sleeve 12, and typically share a common central axis. It is contemplated that crimping sleeve 12 comprises a single monolithic member that is machined into the final configuration. Such a monolithic member has advantages from the standpoint of a minimization of components and adds to the robustness of the design (i.e., minimizing leaks at joints and the like). In addition, such a configuration minimizes distortion of the hose (i.e., twisting and the like). Of course, multiple components could be utilized.

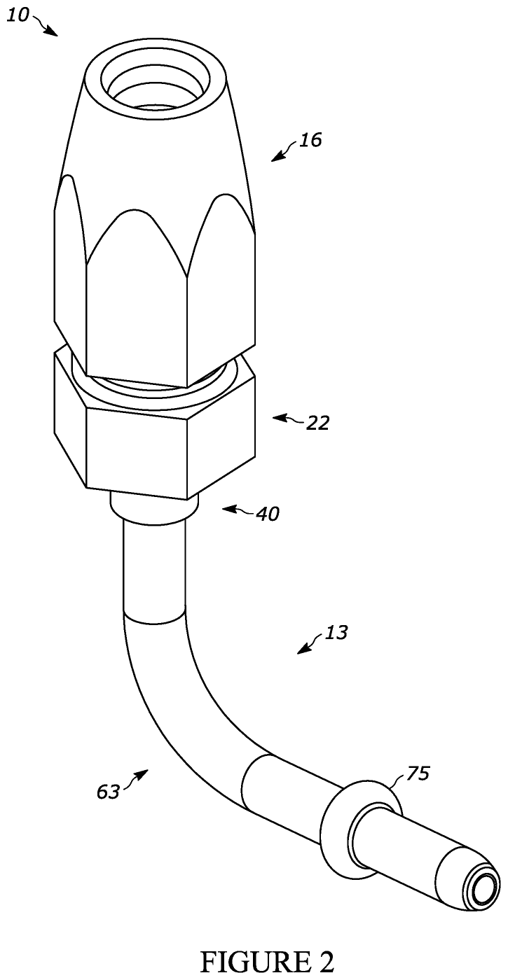

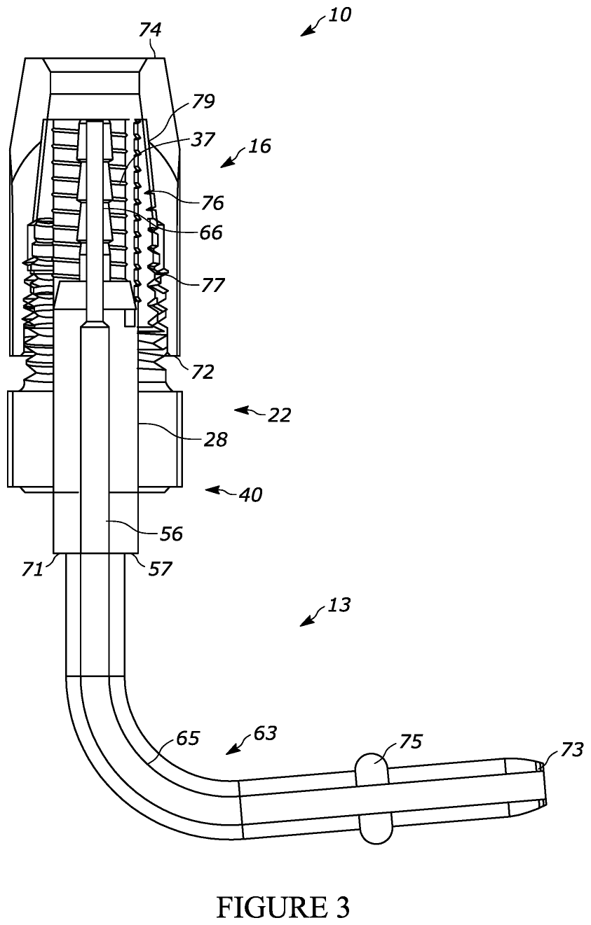

The hose insertion member 14 is shown in FIG. 1 (and also in FIGS. 2 and 3, within the crimping sleeve 12) as comprising an end body 40 and a hose insert 42. The end body 40 includes a first side 50, a second side 52, an outer surface 54, and a central bore 56. Generally, the end body 40 has a substantially uniform diameter between ends thereof, and including a chamfer 55 at the first side 50 thereof, and a square edge 57 at the second side 52 thereof. The end body 40 is of a generally cylindrical configuration and includes a dimension that generally corresponds to the internal bore portion 28 of the end body 20, such that the end body 40 fits snugly within the internal bore portion 28. In another configuration the crimping sleeve 12 and hose insertion member 14 may be machined from a single material.

The hose insert 42 comprises a generally cylindrical configuration that includes a proximal end 60, a distal end 62, an outer surface 64 and a central bore 66. The hose insert 42 extends from the first side 50 of the end body 40 of the hose insertion member 14 and is generally coaxial therewith. The central bore 66 generally corresponds to the central bore 56 of the end body 20. The outer surface 64 of the hose insert 42 includes a pattern 68, which in the configuration shown comprises a plurality of spaced apart ridges each of which encircles the outer surface 64. The edges of which may comprise barbs which tend to allow insertion of a hose (not shown), but provide additional resistance to removal thereof.

At an interface of the hose insert 42 and the first side 50 of the end body 40, a flange 67 is defined. As will be explained, this flange 67 forms the physical stop for the hose that is inserted over the hose insert 42. As will be explained, when installed, the distal end 62 of the hose insert 42 matches the distal end 32 of the crimp sleeve 22. The crimp sleeve 22 is fixedly coupled (e.g., press fit, threaded, brazed, etc.) to the end body 40.

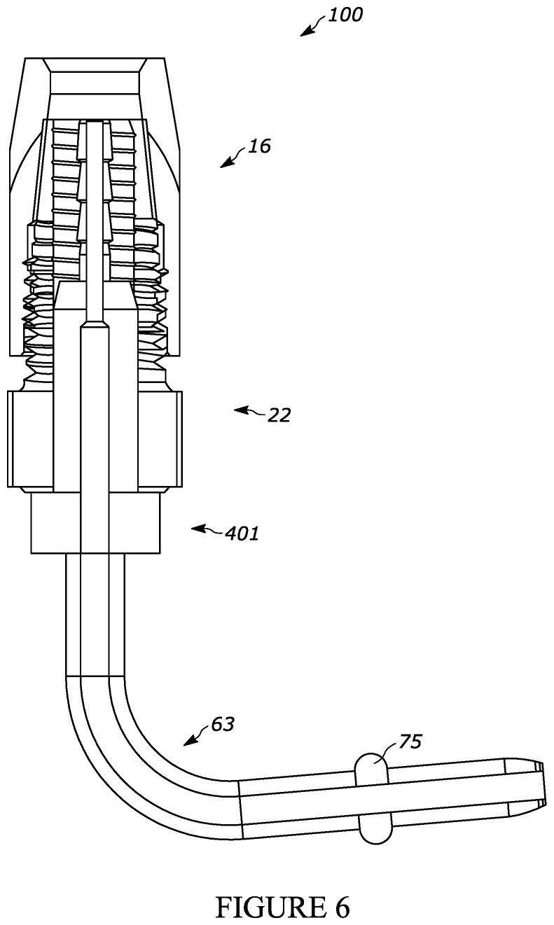

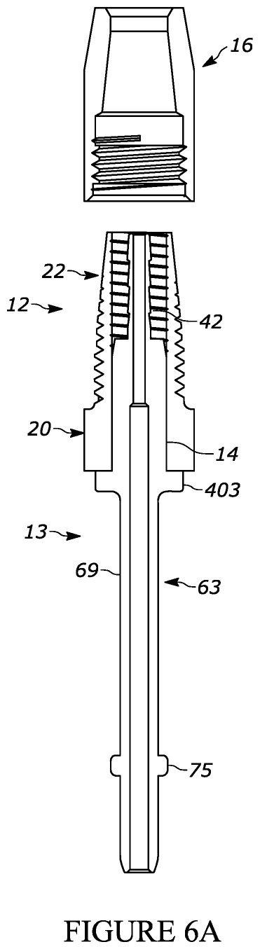

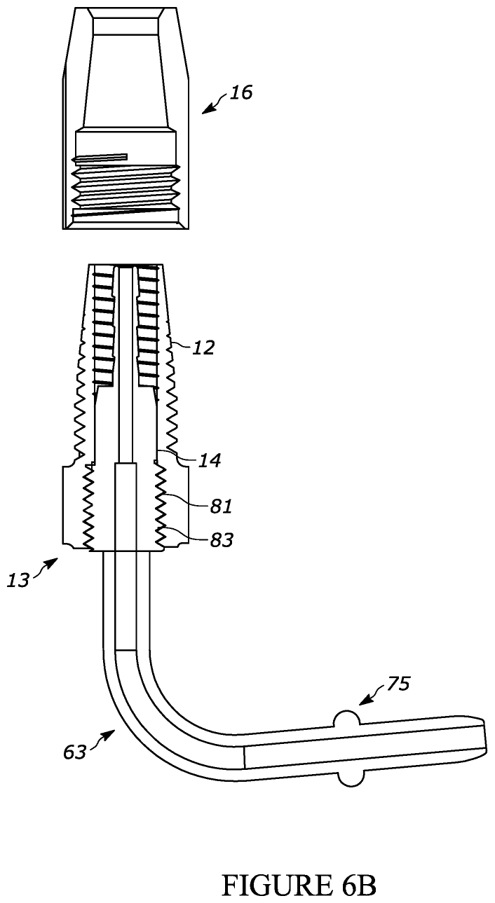

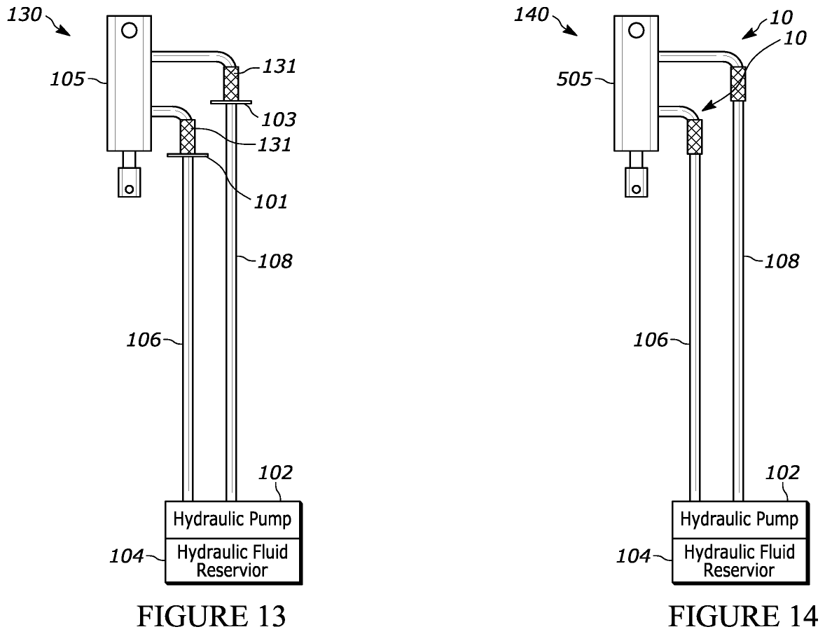

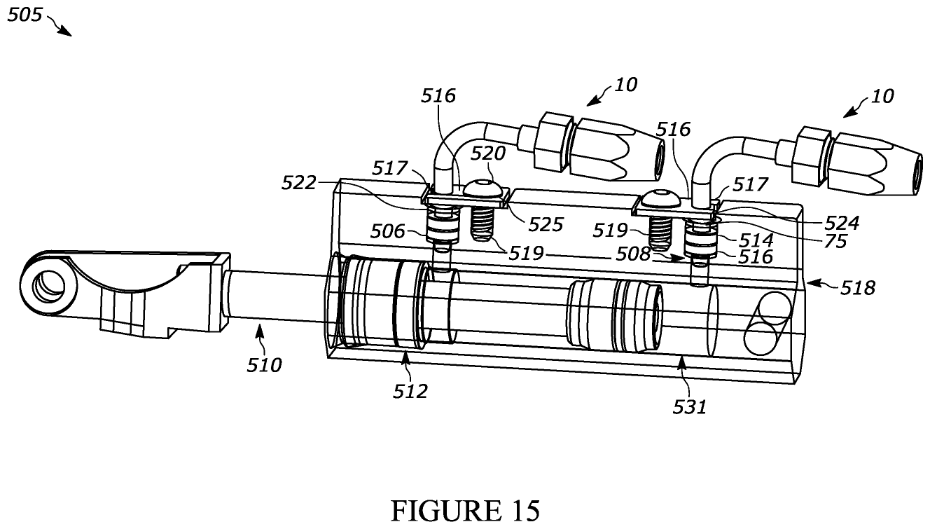

The replacement pipe 63 is integrated with the second side 52 of the end body 40. The replacement pipe 63 includes an internal bore portion 65. In at least one configuration, the internal bore portion 65 of the replacement pipe 63 may be substantially a same diameter as the internal bore portion 28 of the hose insertion member 14 (whereas in other configurations, the diameters may be different). The replacement pipe 63 includes an elbow portion 69 substantially centrally disposed between a first end 71 of the replacement pipe 63 and a second end 73 of the replacement pipe 63. As shown, the elbow portion 69 is less than ninety (90) degrees, which in at least one configuration, substantially matches an angle from a hose coupler that was attached to a convertible top hydraulic cylinder 105 prior to being remanufactured to produce a remanufactured convertible top hydraulic cylinder 505, included within convertible top hydraulic system 140 (FIG. 14). Other angles are possible, among others a 180° angle resulting in a straight replacement pipe (see, i.e., FIG. 6a), as well as angles that are, for example between 60° and 180° and more preferably between 70° and 180°. Also, the replacement pipe 63 is configured with a length so as to extend the clamping nut 16 and the crimping sleeve 12, once coupled, to a point where they meet cut points 101, 103 (FIG. 13) of hydraulic hoses 106, 108 (FIG. 13), such that they substantially match a location where the original couplers 131 were coupled to hydraulic hoses 106, 108 (FIG. 14). In at least one configuration, the second end 73 is tapered, as shown, to allow for ease of insertion of the second end 73 into the remanufactured convertible top hydraulic cylinder 505. Additionally, the second end 73 is sized (e.g., having a particular width) such that the replacement pipe 63 matches a pipe from original couplers 131 coupled to the convertible top hydraulic cylinder 105, that is couplers coupled to the convertible top hydraulic cylinder 105 at a time of manufacture of the convertible top hydraulic cylinder 105. Disposed proximate to the second end 73 is a retention collar 75. The retention collar 75 is integrated with the replacement pipe 63 such that the retention collar 75 prevents the convertible hose connector assembly 10 from separating from the remanufactured convertible top hydraulic cylinder 505 once the convertible hose connector assembly 10 is coupled to the remanufactured convertible top hydraulic cylinder 505, as shown in FIG. 15.

The clamping nut 16 is shown in FIG. 3 as comprising an outer surface 70, an inner end 72, an outer end 74, and a bore 76. In at least one configuration, the outer surface 70 is hexagonal in shape such that a wrench (e.g., open end wrench) can be used to rotate the clamping nut 16 onto the crimp sleeve 22. Of course, other configurations are contemplated. The distal end of the outer surface 70 comprises an inwardly conical or tapered configuration. The bore 76 includes threaded portion 77 and a smooth bore portion 79. The threaded portion 77 is configured to matingly threadingly engage with the thread region 38 of the crimp sleeve 22.

The smooth bore portion 79 generally comprises a diameter that is smaller than the threaded portion 77. The smooth bore portion 79 is configured to have a diameter such that, and as will be explained below, successive engagement of the threaded portion 77 with the threaded region 38 of the crimp sleeve 22 will direct the clamping nut 16 toward the end body 20, and push the outer surface 34 that includes the relief slots 39 inwardly toward the respective hose insert 42, thereby crimping the hose positioned therebetween. In the configuration shown, the smooth bore portion 79 is tapered toward the distal end, although variations are contemplated. In addition, while the smooth bore portion 79 is shown to be smooth, in other configurations, a surface pattern or variation may be present thereon.

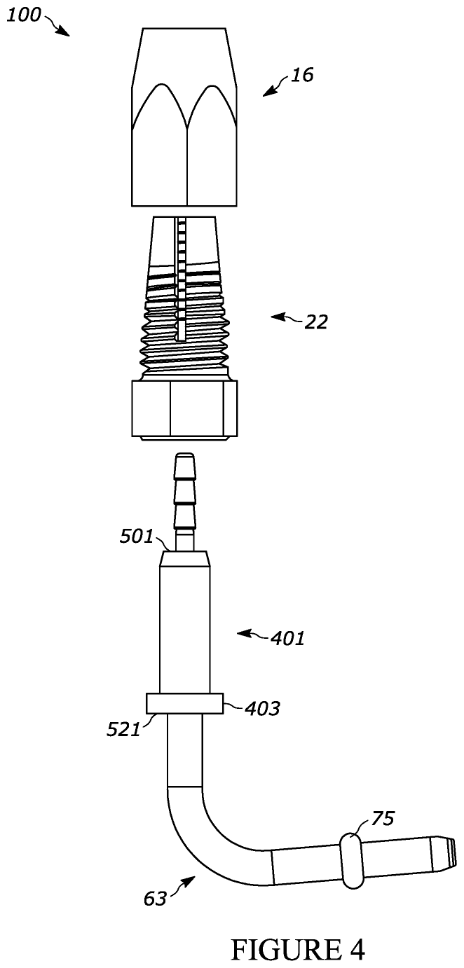

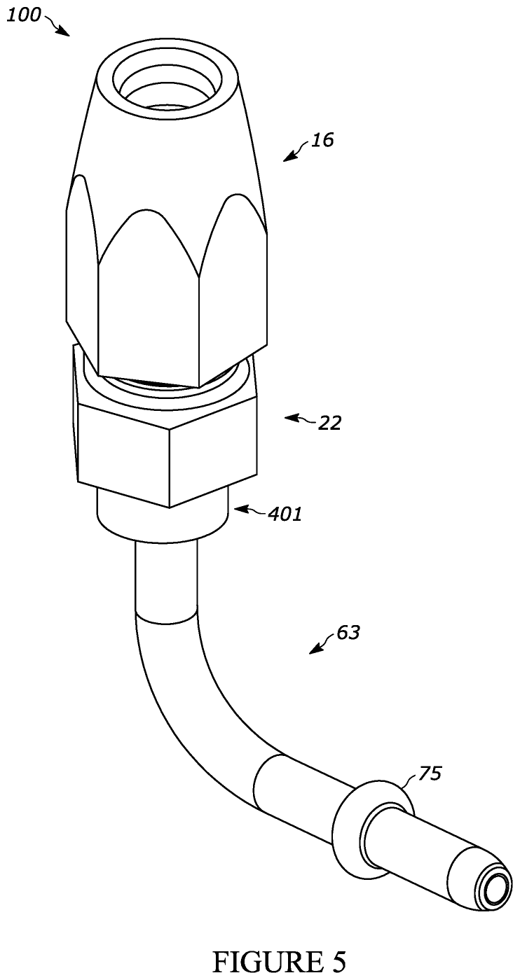

With reference to FIGS. 4-6, another configuration for a hydraulic connector assembly is shown, a convertible hose connector assembly 100. In contrast to the convertible hose connector assembly 10 which includes the end body 40 having a substantially uniform diameter, the convertible hose connector assembly 100 includes another configuration for an end body, end body 401. The end body 401 includes a stop collar 403 disposed at a second side 521 thereof, opposite a first side 501 thereof. The stop collar 403 prevents the end body 401 from being inserted into the crimping sleeve 12 past a point where the stop collar 403 and the crimping sleeve 12 come into contact with each other, as shown in FIGS. 5 and 6, which aids in assembly of these components during manufacture of the convertible hose connector assembly 100. It is contemplated that in place of a stop collar, or in cooperation with a stop collar, with reference to FIG. 6b, a threaded portion 81 may be employed which matingly and threadedly engages with a mating threaded portion 83 on the inner surface of the crimp sleeve 22 at a lower end thereof to receive and couple the two structures together in engagement.

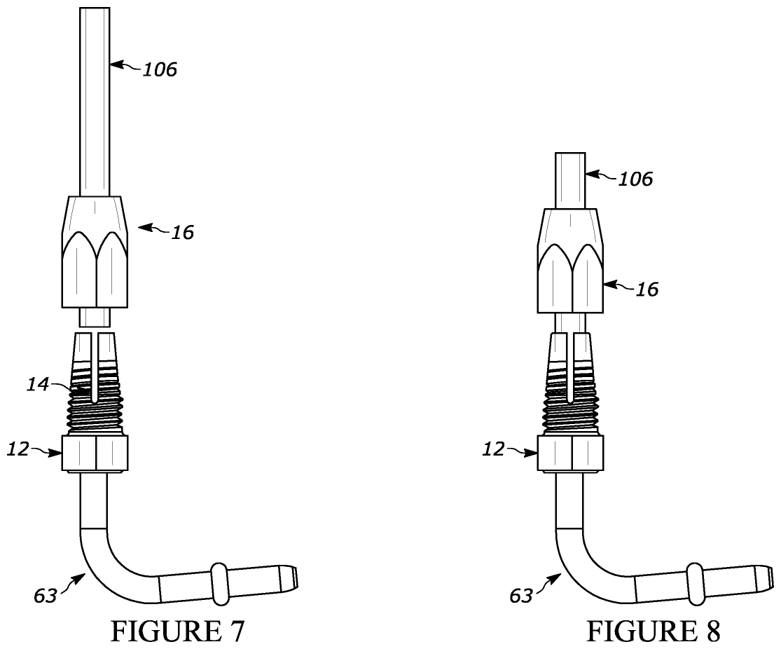

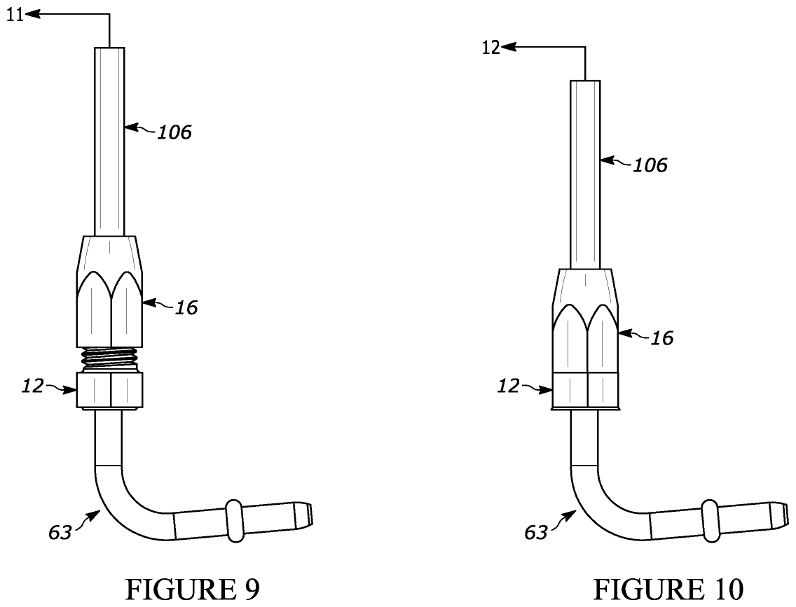

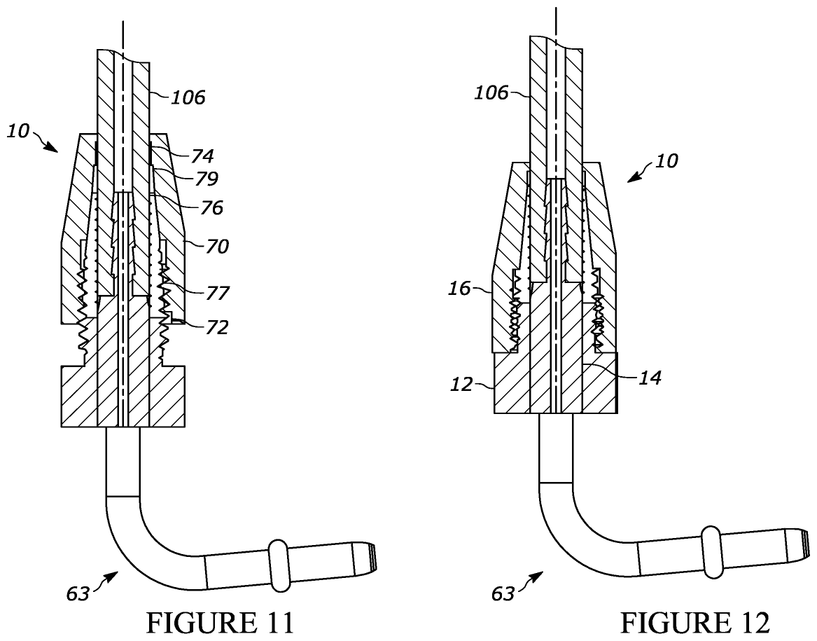

The operation of the convertible hose connector assembly 10, 100 will be set forth with particular reference to FIGS. 7-14. In particular, and as shown in FIG. 13, a conventional convertible top hydraulic system 130 is shown schematically, as further including the cut points 101, 103. That is, a hydraulic pump 102 is presented that is in fluid communication with a hydraulic fluid reservoir 104, along with the convertible top hydraulic cylinder 105. A pair of hydraulic hoses 106, 108 are disposed between the hydraulic pump 102 and the convertible top hydraulic cylinder 105. It will be understood that the pair of hydraulic hoses 106, 108 may be deeply embedded within a vehicle (not shown) with very limited access. In such cases, it is often the case that the most difficult portion of the repair of the convertible top hydraulic cylinder 105 is the removal of the interior, exterior and trim pieces from the vehicle to be able to access and disconnect the hydraulic hoses 106, 108.

In such instances, where replacement of the convertible top hydraulic cylinder 105 is necessitated (i.e., the hydraulic cylinder leaks, hose couplers leak, or has otherwise failed), the present convertible hose connector assembly 10, 100 can be utilized. With continued reference to FIG. 13, the repair as shown schematically, the portion of the hose proximate the convertible top hydraulic cylinder 105 is easily accessible, and, as such, each of the hydraulic hoses 106, 108 will be cut at the cut points 101, 103, respectively, where the hydraulic hoses 106, 108 attached to hydraulic hose couplers 109, 110. Once cut, the convertible top hydraulic cylinder 105 can be remanufactured and reinstalled into the vehicle. The reason that the hydraulic hoses 106, 108 are cut is that the hydraulic hoses 106, 108 are permanently coupled to (not detachably coupled or easily separable from) the convertible top hydraulic cylinder 105 at a time of manufacture of the convertible top hydraulic cylinder 105. A pair of convertible hose connector assemblies 10, 100 of the present disclosure can be employed to couple, in fluid communication, the hydraulic hoses 106, 108 at the cut points 101, 103 to the remanufactured convertible top hydraulic cylinder 505 (thereby reusing a majority of the original hydraulic hoses, and removing the need to take apart a vehicle interior to remove the entire length of hydraulic hose that may otherwise be in good condition). Once the hydraulic cylinder is removed, the existing pipes that are emanating from within the body of the cylinder can be removed. Typically, the body is crimped proximate the ports through which the pipes extend, and the crimped portions can be ground or otherwise modified so as to allow for the removal of the pipe from within the ports. Once the pipes are removed, they may be discarded for the replacement pipes, or they may be modified so as to accept a crimping sleeve (by, for example, modifying the existing hose insertion member with threads so as to threadedly engage the crimping sleeve, or modified so as to otherwise facilitate attachment of the crimping sleeve thereto).

More specifically, reference is made to FIGS. 7-12 wherein a sample connection methodology is disclosed. In FIGS. 7-12, the hydraulic hoses 106, 108 are shown as being each coupled to the convertible hose connector assemblies 10, respectively. A single convertible hose connector assembly 10 is discussed herein, with such discussion applying to two (2) examples of the convertible hose connector assembly 10, as shown. In particular, the clamping nut 16 is extended over the end of the hydraulic hoses 106, 108. With reference to FIG. 8, the hose insertion member 14 is pressed into the crimping sleeve 12. In particular, the end body 40 is extended through the internal bore portion 28 of the crimp sleeve 22. The insertion continues until the hose insert is fully inserted and positioned as desired. In the configuration shown, at a full insertion, the distal end 32 of the crimp sleeve 22 lines up with the distal end 62 of the hose insert 42.

Once the insertion is completed of the hydraulic hoses 106, 108 into the crimping sleeve 12, the hydraulic hoses 106, 108 can be inserted over the respective hose inserts 42. In particular, the end of hose 106 is directed over the distal end 62 of the hose insert 42. The dimensions are such that some resistance will generally be encountered to the insertion. Further insertion eventually directs the end of the hose into contact with the flange 67 which precludes further insertive movement. When inserted, the hydraulic hoses 106, 108 are positioned between the crimp sleeve 22 and the hose insert 42. The barbs on the outer surface of the hose insert 42 generally resist the removal of the hydraulic hoses 106, 108 from the inserted and seated position.

Next, the clamping nut 16 is coupled to the proper end of the crimping sleeve 12. In particular, the clamping nut 16 is directed over the distal end 32 of the crimp sleeve 22. The threaded portion 77 of the bore 76 eventually contacts and initiates mating with the threaded region 38 of the crimp sleeve 22. As the clamping nut 16 is tightened (i.e., directed toward the central body through rotation), the smooth bore portion 79 presses against the outer surface 34 directing the same inwardly. Due to the different relief slots 39, portions of the outer surface 34 are deflected inwardly toward and into contact with the outer surface of the hoses 106, 108. Continued rotation tightens the clamping nut 16 and further inwardly directs the crimp sleeve 22 against the surface of the hydraulic hoses 106. 108, thereby sandwiching the hydraulic hoses 106, 108 between the hose insert 42 on the inside and the internal bore 36 of the crimp sleeve 22. The cooperation of the surface pattern 37 of the internal bore 36 and the pattern 68 of the hose insert 42 provides additional seal strength so as to make a fluid tight connection. Preferably, the clamping nut 16 is further tightened until the inner end 72 of the clamping nut 16 reaches the first side 24 of the end body 20. In other configurations, the clamping nut 16 may be tightened to a particular torque instead of being directed into contact with the end body 20.

Once completed, the air can be bled from the system, and replaced with hydraulic fluid. The use of the two hose connector assemblies provides the remanufactured convertible top hydraulic cylinder 505 with the ability to take advantage of existing hoses that are already installed, thereby not requiring the extensive removal process. It will be understood that the convertible hose connector assembly 10, 100 of the present disclosure is configured to withstand large pressures of the type that would be found on such hydraulic equipment which is generally utilized for the operation of convertible tops. Through testing, such a hose connector assembly maintains a leak proof configuration at pressures in the area of 10,000 psi. Of course, this is merely exemplary, and the disclosure is not limited to use in association with such a pressure or pressures near or approximate to such a pressure.

FIG. 15 illustrates a detailed view of the remanufactured convertible top hydraulic cylinder 505 shown in FIG. 14. In this example, the remanufactured convertible top hydraulic cylinder 505 is shown as including two (2) of the convertible hose connector assembly 10. Typically, a hydraulic cylinder receives pressurized hydraulic fluid through one of the ports 506, 508 to push a rod 510 in either one of a first or a second direction within a cylinder 531. It is understood that the remanufactured convertible top hydraulic cylinder 505 can include two (2) of the convertible hose connector assembly 10, 100, or even one (1) convertible hose connector assembly 10 and one (1) convertible hose connector assembly 100. Thus, either of the convertible hose connector assembly 10 and the convertible hose connector assembly 100 can be attached to either of the hydraulic hoses 106, 108.

The remanufactured convertible top hydraulic cylinder 505 can further include clips 516 to secure, such as with screws (or other fasteners) 520, the two (2) the convertible hose connector assemblies 10, 100 to a body 518 of the remanufactured convertible top hydraulic cylinder 505. In such a configuration, to remanufacture a cylinder, the hydraulic cylinder may be provided with slots 522, 524 which can be formed (i.e., machined in one configuration) into the body 518 proximate the ports 506. 508. The clips 516 are configured to fit within the slots 522, 524 and each include a fork portion 517 which allows for the replacement pipe to extend therethrough. The fork portion 517 is sized so as to permit placement of the replacement pipe therein, while precluding passage of the retention collar 75 therebeyond.

To attach the clips 516 to the hydraulic cylinder 505, bores 519 are defined in body 518 of the hydraulic cylinder. The clips 516 further include openings 525 which correspond to the bores 519, and, the bores 519 may be threaded. Fasteners 520 can be threaded through the openings 525 and into the respective bores 519 so as to clamp the clips 516 therebetween while capturing the retention collar along with the replacement pipe within the respective one of the ports 506, 508. With the configuration shown, the two (2) the convertible hose connector assemblies 10, 100 are able to swivel left and right once coupled to the body 518, while being precluded from removal from within the respective ports 506, 508. In other configurations, the clips may extend over the body without being in slots, and the clips may be coupled unitized (that is joined together) and attached to the body through other structures, such as adhesion, interference fit, riveting, bolting or otherwise.

The hydraulic cylinder 105 can fail at any number of places. For example, the hydraulic cylinder 105 can fail at a seal within the body 518, this seal being replaced with a new rod seal 512 to create the remanufactured convertible top hydraulic cylinder 505. The hydraulic cylinder 105 can also fail where the hydraulic hoses 106, 108 attach to the body 518. The remanufactured convertible top hydraulic cylinder 505 further includes new bushings 514 (e.g., brass bushings) and new seals 515 (e.g., O-rings) for each of the convertible hose connector assemblies 10, 100, the bushings 514 allowing the convertible hose connector assemblies 10, 100 to swivel left and right. In some instances, it may not be necessary to remove or replace the bushings and/or the seal.

Also, the replacement pipe 63 can be made at various angles and lengths. For example, a first convertible hose connector assembly 10 can include an elbow portion 69 that has a different angle than a second convertible hose connector assembly 10. Also, the lengths of the replacement pipe 63 can vary depending upon where the hydraulic hoses 106, 108 are disposed on a particular vehicle. For example, a first convertible hose connector assembly 10 can include a taller replacement pipe 63 than a second convertible hose connector assembly 10, such that the hydraulic hoses 106, 108 can be stacked atop one another. Thus, the convertible hose connector assemblies 10, 100 can be configured to match whatever configuration is utilized for a particular vehicle being serviced. It is further contemplated, as indicated above, that the elbow portion may be straight (i.e., 180° thereby defining a straight member).

The foregoing description merely explains and illustrates the disclosure and the disclosure is not limited thereto except insofar as the appended claims are so limited, as those skilled in the art who have the disclosure before them will be able to make modifications without departing from the scope of the disclosure.

What is claimed is:

1. A hose connector assembly comprising:
an attachment assembly including:
a pipe having a first end and a second end, the replacement pipe having an internal bore extending therethrough and a retention collar spaced apart from the second end;
a hose insert positioned at the first end of the pipe, the hose insert having a proximal end and a distal end, and a central bore that corresponds to the internal bore of the pipe, with an outer surface having a pattern disposed thereon;
a hose insertion member positioned between the pipe and the hose insert having an outer surface, and a second central bore that corresponds to the central bore of the hose insert, the hose insertion member defining a flange at the proximal end of the hose insert;
a crimping sleeve attachable to the hose insertion member, the crimping sleeve having an end body and a crimp sleeve, the crimp sleeve having an internal bore and an outer surface, the outer surface having a threaded portion and at least one relief slot extends through the crimp sleeve; and
a clamping nut having a bore with a threaded portion interfaceable with the threaded portion of the crimp sleeve, whereupon tightening of the clamping nut directs the inner bore proximate the at least one relief slot toward the outer surface of the hose insert, whereupon a hose portion positioned therebetween can be clamped between the outer surface of the hose insert and the inner bore in sealed engagement.

2. The hose connector assembly of claim 1 wherein the pipe further includes an elbow portion between the first end and the second end thereof.

3. The hose connector assembly of claim 2 wherein the elbow portion comprises an angle of between 60° and 180°.

4. The hose connector assembly of claim 1 wherein the crimping sleeve is attached to the hose insertion member through an interference fit a threaded engagement and a brazed connection.

5. The hose connector assembly of claim 1 wherein the attachment assembly comprises a single monolithic member.

6. The hose connector assembly of claim 1 wherein the hose insertion member further includes a stop collar positioned at a second side thereof, wherein the stop collar interfaces with the end body of the crimping sleeve.

7. The hose connector assembly of claim 1 wherein the crimping sleeve further includes an outer surface configured for engagement by a wrench.

8. The hose connector assembly of claim 7 wherein the crimping sleeve further includes an outer surface configured for engagement by a wrench.

9. A hydraulic cylinder comprising:
a body having at least one port in communication with a cylinder having a rod slidably movable within the cylinder;
a hose connector assembly including:
an attachment assembly including:
a pipe having a first end and a second end, the replacement pipe having an internal bore extending therethrough and a retention collar spaced apart from the second end;
a hose insert positioned at the first end of the pipe, the hose insert having a proximal end and a distal end, and a central bore that corresponds to the internal bore of the pipe, with an outer surface having a pattern disposed thereon;
a hose insertion member positioned between the pipe and the hose insert having an outer surface, and a second central bore that corresponds to the central bore of the hose insert, the hose insertion member defining a flange at the proximal end of the hose insert;
a crimping sleeve attachable to the hose insertion member, the crimping sleeve having an end body and a crimp sleeve, the crimp sleeve having an internal bore and an outer surface, the outer surface having a threaded portion and at least one relief slot extends through the crimp sleeve; and
a clamping nut having a bore with a threaded portion interfaceable with the threaded portion of the crimp sleeve, whereupon tightening of the clamping nut directs the inner bore proximate the at least one relief slot toward the outer surface of the hose insert, whereupon a hose portion positioned therebetween can be clamped between the outer surface of the hose insert and the inner bore in sealed engagement.

10. The hydraulic cylinder of claim 9 wherein the pipe further includes an elbow portion between the first end and the second end thereof.

11. The hydraulic cylinder assembly of claim 10 wherein the elbow portion comprises an angle of between 60° and 180°.

12. The hydraulic cylinder assembly of claim 9 wherein the crimping sleeve is attached to the hose insertion member through an interference fit a threaded engagement and a brazed connection.

13. The hydraulic cylinder assembly of claim 9 wherein the attachment assembly comprises a single monolithic member.

14. The hydraulic cylinder assembly of claim 9 wherein the hose insertion member further includes a stop collar positioned at a second side thereof, wherein the stop collar interfaces with the end body of the crimping sleeve.

15. The hydraulic cylinder assembly of claim 9 wherein the crimping sleeve further includes an outer surface configured for engagement by a wrench.

16. The hydraulic cylinder of claim 9 wherein the crimping sleeve further includes an outer surface configured for engagement by a wrench.

17. The hydraulic cylinder of claim 9 wherein the hydraulic cylinder further includes a clip engageable with the retention collar of the pipe that is positioned within the port thereof, to preclude removal of the pipe from within the port.

18. The hydraulic cylinder of claim 17 wherein the clip includes a fork portion with the pipe extending through the fork portion, and further comprising a fastener attaching the clip to the body.

19. The hydraulic cylinder of claim 9 wherein the at least one port comprises a pair of ports, each having a hose connector assembly interfaced therewith.

20. A method of rebuilding a cylinder comprising the steps of:
removing at least one pipe from a port of a body of a cylinder;
providing a hose connector assembly of claim 1;
inserting the pipe of the hose connector assembly into the port of a body of a cylinder;
coupling the pipe so as to preclude removal from within the port;
inserting a hose over the hose insert thereof; and
fastening the clamping nut to the clamping sleeve so as to sealingly clamp the hose to the hose insert.
